(19) United States
(12) Patent Application Publication
(10) Pub. No.: US 2006/0134957 A1
(43) Pub. Date: Jun. 22, 2006

(54) Adjustable stop

(75) Inventor: W. Robert Cornwell, Ronan, MT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Jore Corporation, Pasco, WA (US)

(21) Appl. No.: 11/021,467

(22) Filed: Dec. 22, 2004

(51) Int. Cl. H01R 4/60

(52) U.S. Cl. 439/190

(57) ABSTRACT

An adjustable stop (20) includes an inner collar (22) and an outer collar (24). In one embodiment the inner collar has first and second inner collar contact surfaces (46, 50) in opposed disposition along a length of the inner collar. The outer collar is coupled to the inner collar and reciprocable between a locked position and first and second unlocked positions.

### FIELD OF THE INVENTION

The embodiments described herein relate generally to collar stops, and more specifically to adjustable stop collar assemblies.

### BACKGROUND OF THE INVENTION

Adjustable collar stops are known in the art and have many applications. For example, when drilling, a collar stop can be placed along a drill bit to prevent the drill from going too far into the wood. See U.S. Pat. No. 4,955,766, issued to Sommerfeld, which describes a stop collar on a drill bit that engages a stop flange.

None of the adjustable stops currently available in the marketplace are re-positionable by using a simple pushing or pulling motion, such as by an operator's thumb. Therefore, there exists a need for an adjustable stop that can be easily re-positioned along a shaft by a pushing or pulling motion.

### SUMMARY OF THE INVENTION

An adjustable stop includes an inner collar and an outer collar. In one embodiment, the inner collar has first and second inner collar contact surfaces in opposed disposition along a length of the inner collar. The outer collar is coupled to the inner collar and reciprocable between a locked position and first and second unlocked positions.

In another embodiment, the adjustable stop includes an inner collar adapted to releasably receive a shaft with adjustment grooves. The inner collar includes first and second contact surfaces. A biasing member is associated with the inner collar and has first and second contact surfaces. An outer collar, having first and second contact surfaces, is positionable between a locked position, a first unlocked position, and a second unlocked position relative to the inner collar. When the outer collar is in the locked position, the first biasing member contact surface is seated against the first inner collar contact surface, and the second biasing member contact surface is seated against the second inner collar contact surface. When the outer collar is in the first unlocked position, the first biasing member contact surface is seated against the first inner collar contact surface, and the second biasing member contact surface is seated against the second outer collar contact surface. And, when the outer collar is in the second unlocked position, the first biasing member contact surface is seated against the first outer collar contact surface, and the second biasing member contact surface is seated against the second inner collar contact surface.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric view of an adjustable stop constructed in accordance with one embodiment of the present invention;

FIG. 2 is an exploded view of the adjustable stop of FIG. 1;

FIG. 3 is a cross-sectional side view of the adjustable stop of FIG. 1, shown in a locked position;

FIG. 4 is a cross-sectional side view of the adjustable stop of FIG. 1, shown in a first unlocked position displaced from the locked position of FIG. 3;

FIG. 5 is a cross-sectional side view of the adjustable stop of FIG. 1, shown in a second unlocked position displaced from the locked position of FIG. 3;

FIG. 6 is an isometric view of the adjustable stop of FIG. 1 surrounding a grooved shaft;

FIG. 7 is an isometric view of an adjustable stop constructed in accordance with a second embodiment of the present invention;

FIG. 8 is a cross-sectional side planar view of the adjustable stop of FIG. 7, shown in a first position;

FIG. 9 is a cross-sectional side planar view of the adjustable stop of FIG. 7, shown in a second position; and

FIG. 10 is an isometric view of the adjustable stop of FIG. 7 surrounding a grooved shaft.

### DETAILED DESCRIPTION OF THE PREFERRED EMBODIMENT

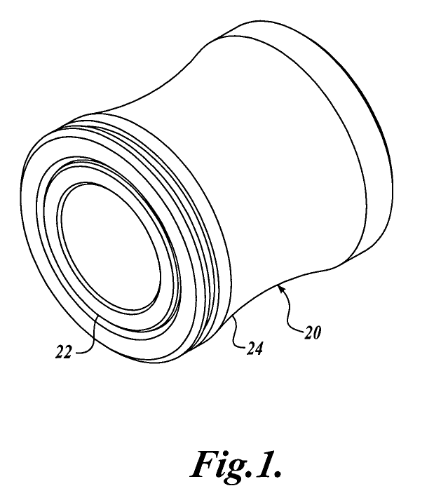

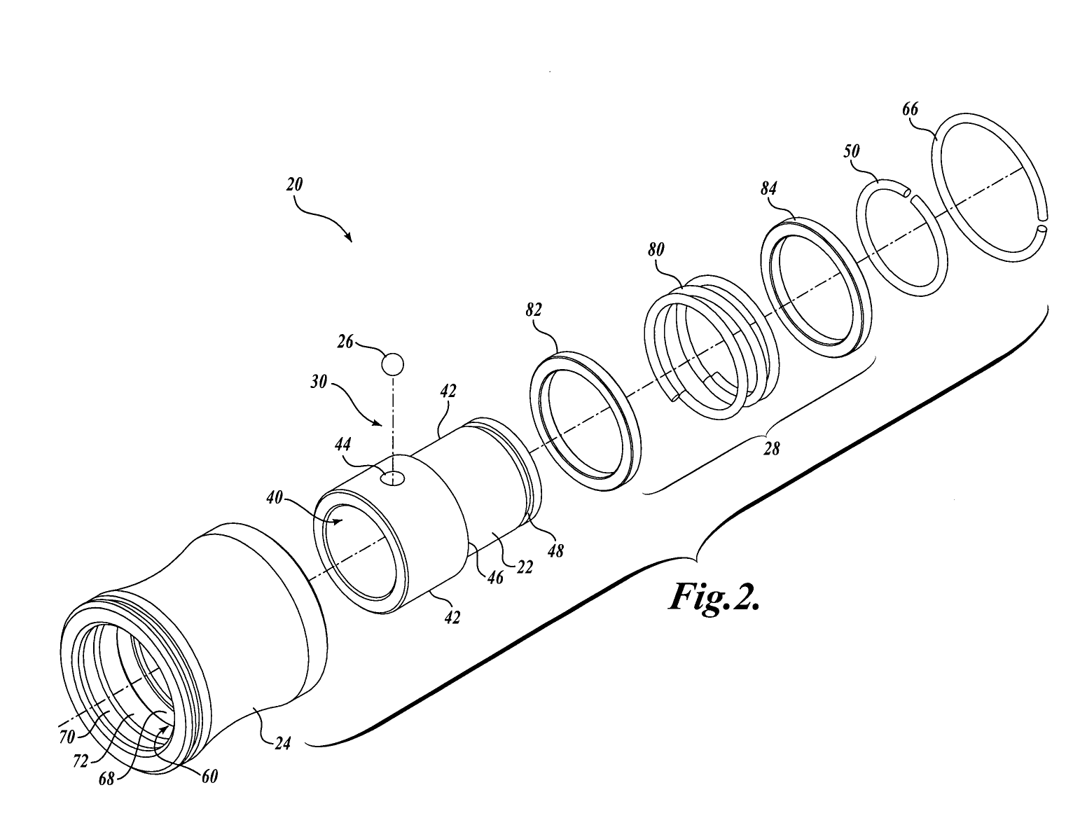

An adjustable stop 20 constructed in accordance with one embodiment of the present invention may be best understood by referring to FIGS. 1 and 2. The adjustable stop 20 generally includes an inner collar 22, and an outer collar 24 slidably coupled to the inner collar 22. The adjustable stop 20 further includes a biasing assembly 28 and a locking mechanism 30.

Adjustable stops 20 without biasing assemblies 28 are also within the scope of the present invention.

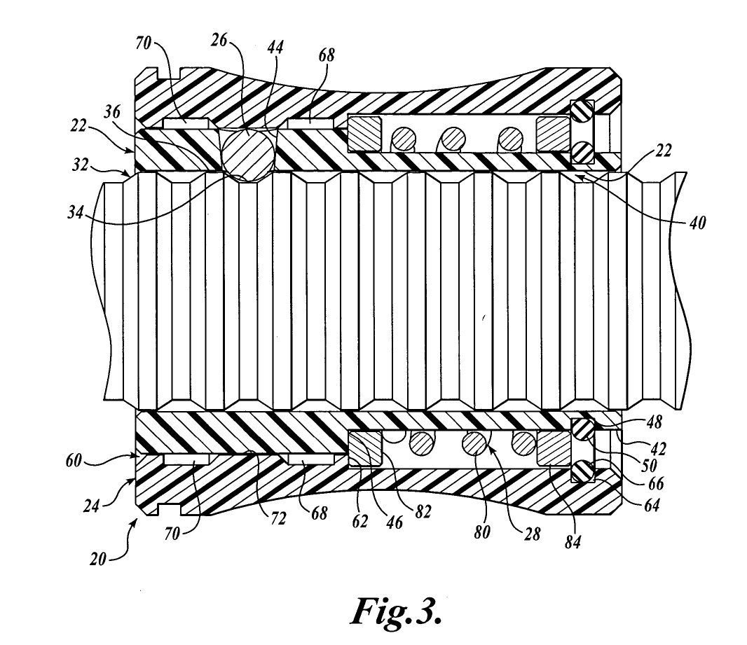

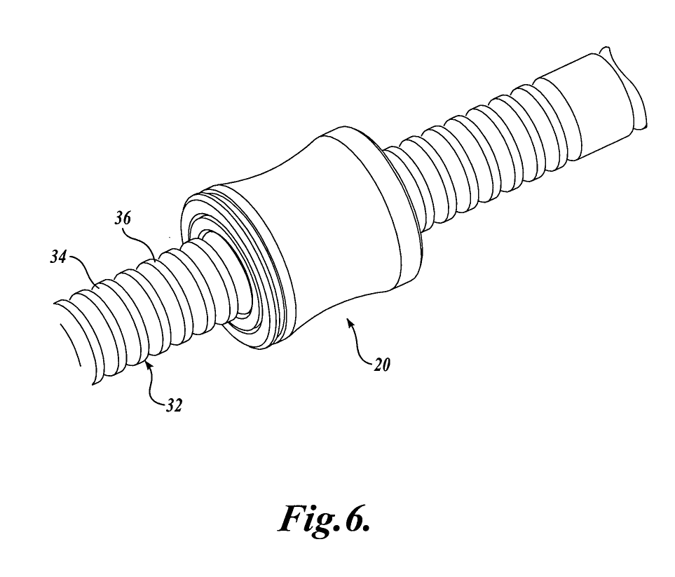

The inner collar 22 is suitably a barrel-shaped member and includes a longitudinally extending channel 40 and an outer surface 42. The channel 40 is sized and configured to receive a shaft 32 (FIGS. 3 and 6), as is described in greater detail below.

The inner collar 22 includes a tapered hole 44 extending from the outer surface 42 to the channel 40. The tapered hole 44 is oriented such that it tapers from an opening located on the outer surface 42 through to an opening in the channel 40. The tapered hole 44 is sized and configured to receive a ball bearing 26. As received in the tapered hole 44, the ball bearing 26 is positioned to selectively engage an adjustment groove 34 of the shaft 32 (FIGS. 3 and 6) to releasably lock the adjustable stop 20 at a designated position along the shaft 32. The ball bearing 26 and the tapered hole 44 define the locking mechanism 30 of the adjustable stop 20. The operation of the locking mechanism 30 will be described in detail below.

As may be best seen by referring to FIGS. 2 and 3, the inner collar 22 further includes an annular shoulder 46 and an annular groove 48 on the outer surface 42. The annular shoulder 46 extends peripherally around the perimeter of the inner collar 22 to define an inner collar first contact surface. The annular groove 48 is sized and configured to receive an inner collar retaining clip 50. This inner collar retaining clip 50 is suitably a round spring, a spring clip, a snap ring, an o-ring, or any other retaining clip known to one of ordinary skill in the art. The inner collar retaining clip 50 creates a protrusion on the outer surface 42 of the inner collar 22.

The inner collar annular shoulder 46 and the inner collar retaining clip 50 define first and second inner collar contact surfaces, respectively. The first and second inner collar contact surfaces are in opposed disposition along a length of the outer surface 42 of the inner collar 22. As such, the first and second contact surfaces are facing one another. The relationship of the inner collar 22 first and second contact surfaces, the outer collar 24, and the biasing assembly 28 will be described in greater detail below.

Still referring to FIGS. 2 and 3, the outer collar 24 of the adjustable stop 20 will now be described in detail. The outer collar 24, like the inner collar 22, is suitably a barrel-shaped member and includes a longitudinally extending channel 60. The channel 60 is sized and configured to be received on, or slidably coupled to, the inner collar 22.

The outer collar 24 includes an annular shoulder 62 and an annular groove 64 formed within the channel 60. The annular shoulder 62 defines a first outer collar contact surface. The annular groove 64 is sized and configured to receive an outer collar retaining clip 66. This outer collar retaining clip 66 is suitably a round spring, a spring clip, a snap ring, an o-ring, or any other retaining clip known to one of ordinary skill in the art. The outer collar retaining clip 66 creates a protrusion or a second outer collar contact surface along the outer collar channel 60.

As configured, the outer collar annular shoulder 62 and the outer collar retaining clip 66 define the first and second outer collar contact surfaces, respectively. The first and second outer collar contact surfaces extend from the outer collar channel 60 and are in opposed disposition with one another along the inner surface of the outer collar 24. The relationship of the inner collar 22 first and second contact surfaces, the outer collar 24 first and second contact surfaces, and the biasing assembly 28 will be described in greater detail below.

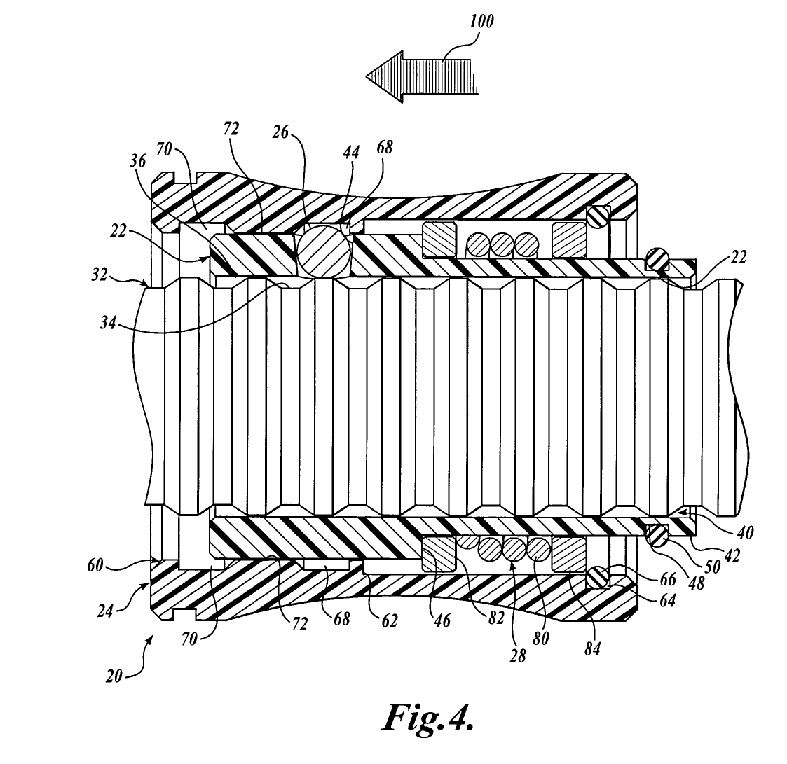

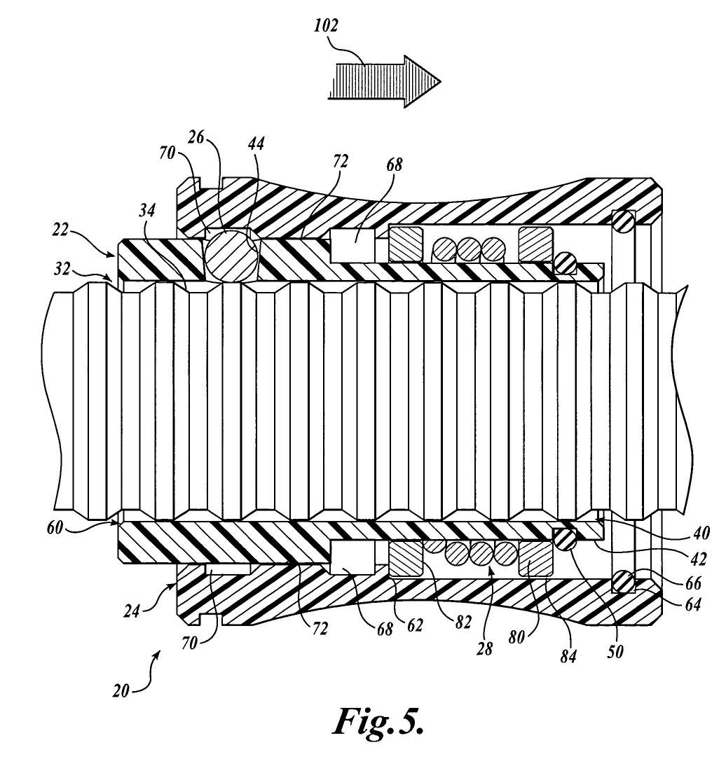

The outer collar 24 further includes first and second ball bearing clearance grooves 68 and 70 formed within the channel 60. The ball bearing clearance grooves 68 and 70 are sized and configured to selectively receive a portion of the ball bearing 26 when the outer collar 24 is reciprocated into one of two unlocked positions (FIGS. 4 and 5), as described in detail below. The first and second ball bearing clearance grooves 68 and 70 are spaced by a cammed contact surface 72 extending radially inward within the channel 60.

Still referring to FIGS. 2 and 3, the biasing assembly 28 will now be described in detail. The biasing assembly 28 is slidably, or moveably disposed on the outer surface 42 of the inner collar 22. In the illustrated embodiment of FIG. 2, the biasing assembly 28 includes means for biasing, such as a spring or biasing member 80. The spring 80 biases the adjustable stop 20 into a locked position as described in greater detail below.

Although a spring 80 is illustrated as one suitable means for biasing, it should be apparent that other structures are also within the scope of the present invention. Other such means for biasing include springs, belts, fluid compressions systems, wave springs, or any other means for biasing known to one of ordinary skill in the art.

The adjustable stop 20 also includes first and second washers 82 and 84. The first and second washers 82 and 84 are disposed at opposite ends of the spring 80. As assembled in the illustrated embodiment of FIG. 3, the first and second washers 82 and 84 form first and second biasing assembly contact surfaces, respectively.

In another embodiment, the biasing assembly 28 may not include first and second washers 82 and 84. In such an embodiment, the fore and aft ends of the spring 80 define the first and second contact surfaces for the biasing assembly 28. As a result, other biasing assembly configurations are also within the scope of the present invention.

Still referring to FIG. 3, the biasing assembly 28 is disposed on the outer surface 42 of the inner collar 22 between the inner collar annular shoulder 46 and the inner collar retaining clip 50.

Referring to FIG. 6, the adjustable stop 20 receives and surrounds a grooved cylindrical shaft 32 to be releasably positioned as a stop along the shaft 32. In the illustrated embodiment, as a non-limiting example, the grooved shaft 32 has a plurality of adjustment grooves 34 equally spaced from one another by annular rims 36.

The adjustment stops are based on the distance between the grooves 34 along the shaft 32. In other embodiments, the shaft may have a plurality of adjustment grooves that are not equally spaced from one another. Moreover, in other embodiments, the shaft may have a plurality of adjustment grooves spaced at lesser or greater intervals than the intervals of the illustrated embodiment of FIG. 6.

Operation of the adjustable stop 20 may be best understood by referring to FIGS. 2-5. Generally described, the adjustable stop 20 is biased in a locked position (FIG. 3), but is selectively positionable between a first unlocked position (FIG. 4) and a second unlocked position (FIG. 5) by pushing and pulling motions, for example, by the force of a user's thumb, on the outer collar 24.

Referring to FIG. 3, the adjustable stop 20 is biased in the locked position when the ball bearing 26 is displaced into locking engagement with one of the adjustment grooves 34 by the contact surface 72. The contact surface 72 maintains the ball bearing 26 within the adjustment groove 34 to resist movement of the adjustable stop 20 relative to the shaft 32 until an operator selectively displaces the adjustable stop 20 into one of the two unlocked positions (FIGS. 4 and 5). The inner and outer collar annular shoulders 62 and 46 are in alignment with one another to form a single first contact surface, and the inner and outer collar retaining clips 50 and 66 are in alignment with one another to form a single second contact surface.

When the adjustable stop 20 is in the locked position, the inner and outer collar annular shoulders 62 and 46 are in direct contact with the first contact surface (or the first washer 82) of the biasing assembly 28. Additionally, the inner and outer collar retaining clips 50 and 66 are in direct contact with the second contact surface (or the second washer 84) of the biasing assembly 28.

Now referring to FIG. 4, the adjustable stop 20 is positioned in the first “unlocked position,” relative to the locked position as shown in FIG. 3. Force 100 applied axially to the outer collar 24 causes the outer collar 24 to move relative to the inner collar 22. As the outer collar 24 moves relative to the inner collar 22, the spring 80 is compressed between the inner collar annular shoulder 46 (first inner collar contact surface) and the outer collar retaining clip 66 (second outer collar contact surface).

As the adjustable stop 20 is forced into the first unlocked position, the first ball bearing clearance groove 68 aligns with the radially tapered hole 44 in the inner collar 22 and the ball bearing 26 is free to move outwardly into the first ball bearing clearance groove 68. As the ball bearing 26 moves outwardly, the adjustable stop 20 moves into the first “unlocked position,” such that the adjustable stop 20 can move freely along the shaft 32 away from the adjustment groove 34. The adjustable stop 20 can now be re-positioned along the shaft 32 (FIG. 6). When the force 100 is removed from the outer collar 24, the ball bearing 26 falls between the contact surface 72 and another one of the plurality of adjustment grooves 34 aligned with the tapered hole 44. As configured, the adjustable stop 20 returns to its “locked position” (FIG. 3).

The same result can be achieved by exerting a force 102 in the opposite direction on the outer collar 24. As best seen by referring to FIG. 5, the adjustable stop 20 is positioned in the second “unlocked position,” relative to the locked position as shown in FIG. 3. Force 102 applied axially to the outer collar 24 causes the outer collar 24 to move relative to the inner collar 22. As the outer collar 24 moves relative to the inner collar 22, the spring 80 again is compressed, but this time between the inner collar retaining clip 50 (second inner collar contact surface) and the outer collar annular shoulder 62 (first outer collar contact surface).

As the adjustable stop 20 is forced into the second unlocked position, the second ball bearing clearance groove 70 aligns with the radially tapered hole 44 in the inner collar and the ball bearing 26 is free to move outwardly into the second ball bearing clearance groove 70. As the ball bearing 26 moves outwardly, the adjustable stop 20 moves into the second “unlocked position,” such that the adjustable stop 20 can move freely along the shaft 32. The adjustable stop 20 can be re-positioned along the shaft 32 when the force 102 is removed from the outer collar 24 and the ball bearing 26 falls between the contact surface 72 and another one of the plurality of adjustment grooves 34 along the shaft 32. When the force 102 is removed, the adjustable stop 20 returns to its “locked position” (FIG. 3).

The biasing assembly 28 is thus disposed on the inner collar 22 for reciprocating movement and is compressible in both first and second unlocked positions (respectively, FIGS. 4 and 5). When forces 100 and 102 are removed, the adjustable stop 20 returns to its biased or locked position, as shown in FIG. 3.

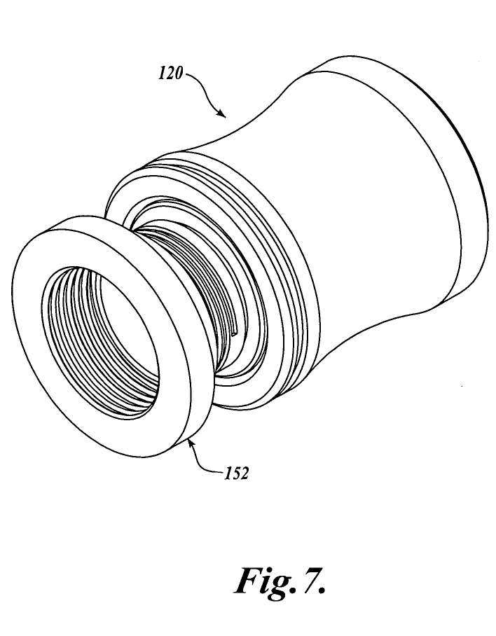

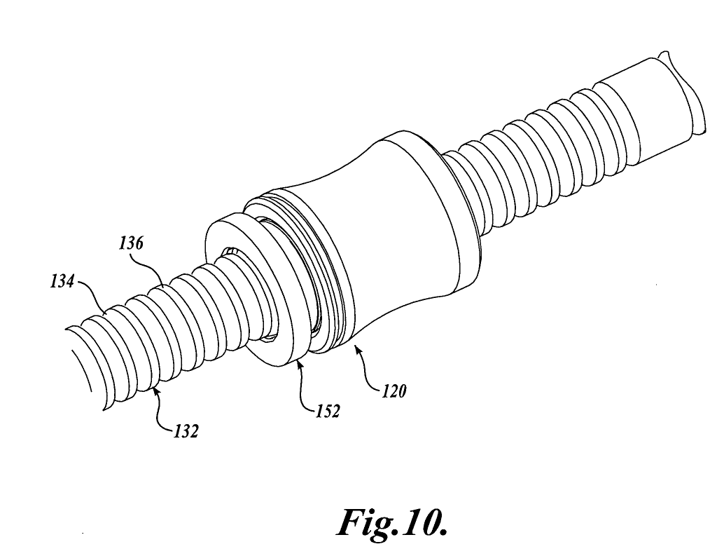

Now referring to FIGS. 7-10, an adjustable stop 120 constructed in accordance another embodiment of the present invention will be described in greater detail. The adjustable stop 120 is substantially identical in materials and operation as the previously described embodiment with the exception that the adjustable stop 120 includes means for fine adjustment of the positioning of the adjustable stop 120 along a shaft 132, such as an extension collar 152. Although an extension collar 152 is one example of means for fine adjustment, other suitable structures are also within the scope of the present invention. As a non-limiting example, such structures may include attachment clips.

As may be best seen by referring to FIGS. 7-9, the extension collar 152 includes internal threads 154, and attaches by being threaded on the adjustable stop 120. In that regard, the inner collar 122 includes an annular appendage 156 with external threads 158. The extension collar 152 attaches to the inner collar 122 by being threaded along the annular appendage 156 of the inner collar 122.

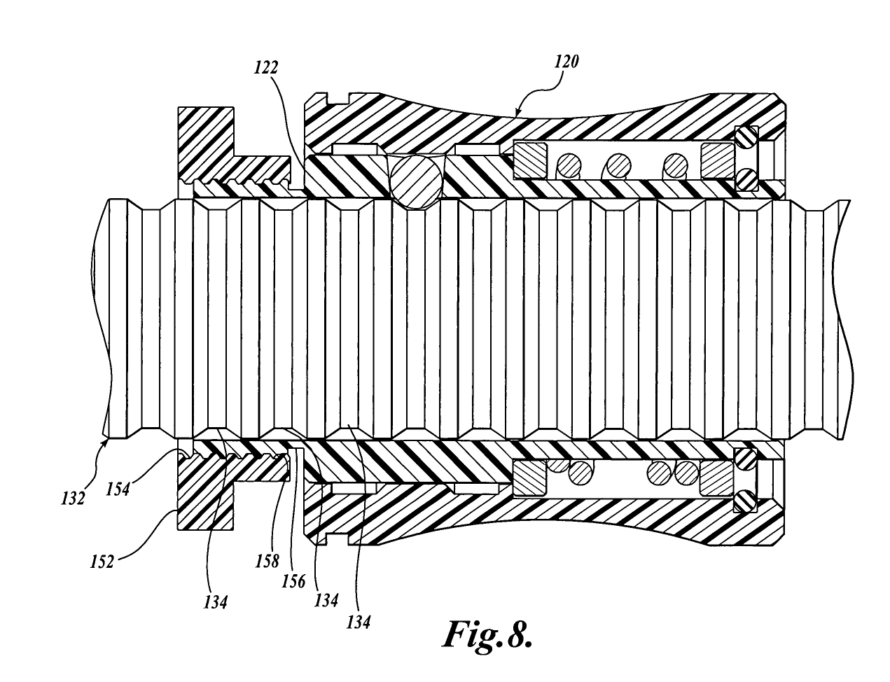

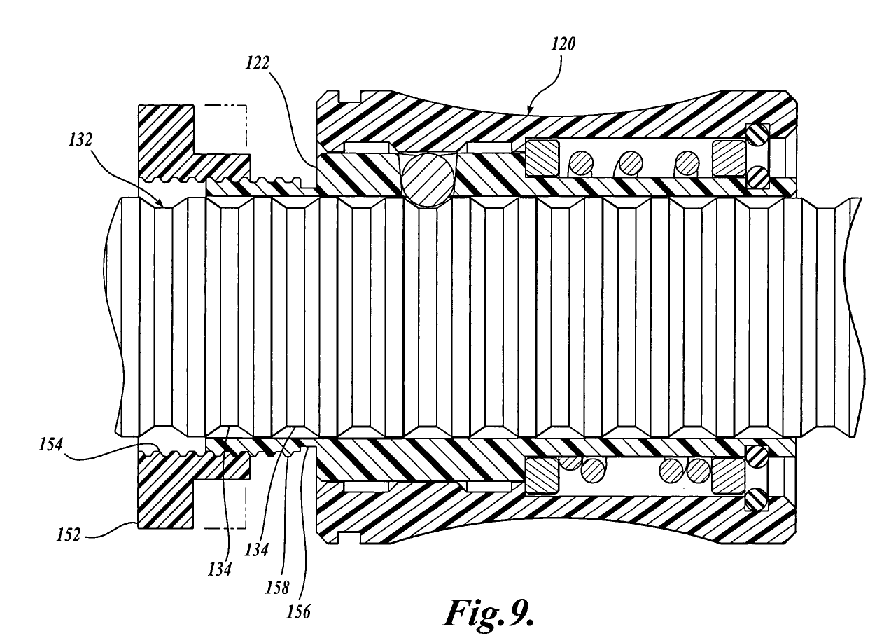

The extension collar 152 allows for fine adjustment of the positioning of the adjustable stop 120 along the shaft 132 by being positionable along the annular appendage 156 of the inner collar 122. For example, referring to FIG. 8, the extension collar 152 is threaded on the annular appendage 156 in a first position near the inner collar 122. Referring to FIG. 9, the extension collar 152 is threaded on the annular appendage 156 in a second position further from the inner collar 122. In this manner, the position of the extension collar 152 can be finely adjusted by threading or unthreading to create finer stop points in between the larger stop points of the adjustment grooves 134.

Although the extension collar 152 attaches to the adjustable stop 120 by being threaded on the annular appendage 156 of the inner collar 122, it should be apparent that other attachment structures are also within the scope of this embodiment of the present invention. As a non-limiting example, such attachment structures may include set screw attachment mechanisms.

While the preferred embodiment of the invention has been illustrated and described, it will be appreciated that various changes can be made therein without departing from the spirit and scope of the invention.

1. An adjustable stop, comprising:
(a) an inner collar having first and second inner collar contact surfaces in opposed disposition along a length of the inner collar; and
(b) an outer collar coupled to the inner collar and selectively reciprocable between a locked position and first and second unlocked positions.

2. The adjustable stop of claim 1, wherein the first inner collar contact surface is a shoulder and the second inner collar contact surface is a retaining clip.

3. The adjustable stop of claim 1, wherein the outer collar is normally positioned in the locked position.

4. The adjustable stop of claim 3, wherein the outer collar is positionable into the first unlocked position.

5. The adjustable stop of claim 4, wherein the outer collar is positionable into the second unlocked position.

6. The adjustable stop of claim 1, wherein the inner collar is adapted to receive a shaft with adjustment grooves.

7. The adjustable stop of claim 1, further comprising means for fine adjustment.

8. The adjustable stop of claim 1, further comprising an extension collar.

9. An adjustable stop, comprising:
(a) an inner collar having first and second inner collar contact surfaces;
(b) an outer collar disposed on the inner collar; and
(c) a biasing member disposed between the first and second inner collar contact surfaces and operatively contacting the outer collar.

10. The adjustable stop of claim 9, wherein the first inner collar contact surface is a shoulder and the second inner collar contact surface is a retaining clip.

11. The adjustable stop of claim 9, wherein the biasing member is a spring.

12. The adjustable stop of claim 9, wherein the outer collar includes a first outer collar contact surface and a second outer collar contact surface.

13. The adjustable stop of claim 9, wherein the biasing member includes a first biasing member contact surface and a second biasing member contact surface.

14. The adjustable stop of claim 13, wherein the collar is biased in a locked position, wherein the first biasing member contact surface is seated against the first inner collar contact surface, and the second biasing member contact surface is seated against the second inner collar contact surface.

15. The adjustable stop of claim 14, wherein the collar is positionable in a first unlocked position, wherein the first biasing member contact surface is seated against the first inner collar contact surface, and the second biasing member contact surface is seated against the second outer collar contact surface.

16. The adjustable stop of claim 15, wherein the collar is positionable in a second unlocked position, wherein the first biasing member contact surface is seated against the first outer collar contact surface, and the second biasing member contact surface is seated against the second inner collar contact surface.

17. The adjustable stop of claim 9, wherein the inner collar is adapted to receive a shaft with adjustment grooves.

18. An adjustable stop, comprising:
(a) an inner collar having first and second inner collar contact surfaces;
(b) an outer collar disposed on the inner collar; and
(c) means for biasing the adjustable stop into a locked position disposed between the first and second inner collar contact surfaces.

19. An adjustable stop, comprising:
(a) an inner collar having first and second inner collar contact surfaces in opposed disposition along a length of the inner collar;
(b) an outer collar coupled to the inner collar and selectively reciprocable between a locked position and first and second unlocked positions; and
(c) an extension collar adjustably attached to the inner collar.

20. An adjustable stop, comprising:
(a) an inner collar having a socket adapted to receive a shaft, the inner collar having a first inner collar contact surface and a second inner collar contact surface;
(b) a biasing member disposed on the inner collar and moveably disposed between the first and second inner collar contact surfaces; and
(c) an outer collar slidably coupled to the inner collar and adapted for reciprocating movement between a locked position and first and second unlocked positions.

21. An adjustable stop, comprising:
(a) an inner collar adapted to releasably receive a shaft with adjustment grooves, the inner collar having a first contact surface and a second contact surface;
(b) a biasing member associated with the inner collar, the biasing member having a first contact surface and a second contact surface;
(c) an outer collar having a first contact surface and a second contact surface, the outer collar being positionable between a locked position, a first unlocked position, and a second unlocked position relative to the inner collar;
(d) wherein when the outer collar is in the locked position, the first biasing member contact surface is seated against the first inner collar contact surface, and the second biasing member contact surface is seated against the second inner collar contact surface;
(e) wherein when the outer collar is in the first unlocked position, the first biasing member contact surface is seated against the first inner collar contact surface, and the second biasing member contact surface is seated against the second outer collar contact surface; and
(f) wherein when the outer collar is in the second unlocked position, the first biasing member contact surface is seated against the first outer collar contact surface, and the second biasing member contact surface is seated against the second inner collar contact surface.
